(19) United States
(12) Patent Application Publication
(10) Pub. No.: US 2021/0248461 A1
(43) Pub. Date: Aug. 12, 2021

(54) GRAPH ENHANCED ATTENTION NETWORK FOR EXPLAINABLE POI RECOMMENDATION

(71) Applicant: NEC Laboratories America, Inc., Princeton, NJ (US)

(72) Inventors: Wei Cheng, Princeton Junction, NJ (US); Haifeng Chen, West Windsor, NJ (US); Wenchao Yu, Plainsboro, NJ (US)

(21) Appl. No.: 17/153,160

(22) Filed: Jan. 20, 2021

Related U.S. Application Data
(60) Provisional application No. 62/972,693, filed on Feb. 11, 2020.

(51) Int. Cl. G06N 3/08; G06N 3/04

(52) U.S. Cl. CPC G06N 3/08; G06N 3/04

(57) ABSTRACT

A method for employing a graph enhanced attention network for explainable point-of-interest (POI) recommendation (GEAPR) is presented. The method includes interpreting POI prediction in an end-to-end fashion by adopting an adaptive neural network, learning user representations by aggregating a plurality of factors, the plurality of factors including structural context, neighbor impact, user attributes, and geolocation influence, and quantifying each of the plurality of factors by numeric values as feature salience indicators.

### RELATED APPLICATION INFORMATION

This application claims priority to Provisional Application No. 62/972,693, filed on Feb. 11, 2020, the contents of which are incorporated herein by reference in their entirety.

### BACKGROUND

### Technical Field

The present invention relates to point-of-interest (POI) recommendations and, more particularly, to a graph enhanced attention network for explainable POI recommendations.

### Description of the Related Art

Point of interest (POI) recommendation is a useful component in the recommender system family. POI refers to locations that customers of online business directories or review forums are interested in. Such directories or forums are usually named as a location-based social network (LBSN), e.g., Yelp® and Foursquare®, since users interact with each other in various ways such as co-reviewing, co-visiting, or directly connecting via friendship relations. POI recommendation has a wide coverage of scenarios in which the advertised items have significant spatial attributes that strongly influence user decisions. Properly recommending POI relies on understanding user taste, POI's property, geolocation, and their correlations. Varying from simple to sophisticated, existing algorithms are painstakingly customized for more precise user preference modeling, POI profiling, and user-POI relevance estimation. In other words, the development of POI recommendation systems witnesses the utilization of multiple modalities of data to achieve more satisfactory POI recommendations. Shortcomings of existing models include, e.g., inadequate interpretable motivation analysis for POI visits and the absence of an attribute study for users with a diverse background.

### SUMMARY

A computer-implemented method for employing a graph enhanced attention network for explainable point-of-interest (POI) recommendation (GEAPR) is presented. The method includes interpreting POI prediction in an end-to-end fashion by adopting an adaptive neural network, learning user representations by aggregating a plurality of factors, the plurality of factors including structural context, neighbor impact, user attributes, and geolocation influence, and quantifying each of the plurality of factors by numeric values as feature salience indicators.

A non-transitory computer-readable storage medium comprising a computer-readable program is presented for employing a graph enhanced attention network for explainable point-of-interest (POI) recommendation (GEAPR), wherein the computer-readable program when executed on a computer causes the computer to perform the steps of interpreting POI prediction in an end-to-end fashion by adopting an adaptive neural network, learning user representations by aggregating a plurality of factors, the plurality of factors including structural context, neighbor impact, user attributes, and geolocation influence, and quantifying each of the plurality of factors by numeric values as feature salience indicators.

A system for employing a graph enhanced attention network for explainable point-of-interest (POI) recommendation (GEAPR) is presented. The system includes a memory and one or more processors in communication with the memory configured to interpret POI prediction in an end-to-end fashion by adopting an adaptive neural network, learn user representations by aggregating a plurality of factors, the plurality of factors including structural context, neighbor impact, user attributes, and geolocation influence, and quantify each of the plurality of factors by numeric values as feature salience indicators.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an overall pipeline of a Graph Enhanced Attention network for explainable point-of-interest (POI) Recommendation (GEAPR), in accordance with embodiments of the present invention;

FIG. 2 is a block/flow diagram of an exemplary workflow of the method for implementing the GEAPR, in accordance with embodiments of the present invention;

FIG. 3 is a block/flow diagram of exemplary details regarding the workflow of FIG. 2, in accordance with embodiments of the present invention;

FIG. 4 is a block/flow diagram of further exemplary details regarding the workflow of FIG. 2, in accordance with embodiments of the present invention;

FIG. 5 is a block/flow diagram of an example practical application of the GEAPR, in accordance with embodiments of the present invention;

FIG. 6 is block/flow diagram of an exemplary processing system for the GEAPR, in accordance with embodiments of the present invention;

FIG. 7 is a block/flow diagram of an exemplary method for implementing the GEAPR, in accordance with embodiments of the present invention; and

FIG. 8 is a block/flow diagram of exemplary equations employed for the hidden feature representations, in accordance with embodiments of the present invention.

### DETAILED DESCRIPTION OF PREFERRED EMBODIMENTS

First, for motivation analysis, the ranking functions of existing approaches merely fuse the multi-modal information without explicitly quantifying or explaining which modalities are comparatively more important than the others and which are less relevant. However, quantitatively comprehending the key causes of the check-ins is valuable because it is able to measurably interpret the users' mind-sets on choosing the next point-of interest (POI) to visit. For example, some users always check in places their friends have checked in or have suggested, while others tend to visit places that their peer group favors. Such numerical motivation importance measurements can also reasonably provide a clear answer to the following debate. Tobler's first law of geography states that: “Everything is related to everything else, but near things are more related than distant things.” However, other authors state the opposite, that is, a user's visit to certain POI implies exactly her indifference to those nearby, otherwise she would have visited them instead in the first place. With numerical motivation analysis, it becomes easy to capture and interpret the primary causes of user check-ins, e.g., the motivations. In contrast, existing approaches are not adaptive enough to learn different motivations in a transparent way. Existing approaches instead simply use unweighted additions or feature vector concatenations to mingle the intermediate information and produce recommendations. Motivation importance is hardly revealed by these operations. Such discrepancy calls for an effective architecture that is elaborately developed for interpretable motivation analysis with explicit salience distribution on different motivation factors.

Second, existing methods largely ignore user attribute studies, which are also beneficial. The conventional art of item-based recommender systems, e.g., movies and books, have demonstrated the potential of user profile, demographics, and their complex joint effects to enhance recommendation accuracy. Such potential is also plausible in the context of POI recommendation. For example, young people may love to try different restaurants in different locations while seniors may have distance concerns. However, user attribute information has been underestimated even by the recent deep learning-based POI recommendation models, although deeper models have superior ability to fuse different information modalities and capture the corresponding importance. Therefore, it is beneficial to incorporate the user attribute features to comprehensively cover possible motivation factors.

To address the two aforementioned concerns, the exemplary embodiments of the present invention introduce a Graph Enhanced Attention network for explainable POI Recommendation (GEAPR) that recommends POIs in an adaptive and interpretable way. GEAPR leverages not only geographical and social information but also user personal attributes and GEAPR provides an end-to-end justification of the recommendation in the meantime. Specifically, the exemplary embodiments decompose the possible motivating causes into the following factors:

Structural context, where a check-in can be motivated by neighboring users with high structural proximity in the social network since they have a similar social context. This type of stimulus is usually ignored as it is latent and implicit.

Neighbor impact, where impact from direct neighbors, e.g., friends, is another factor of interest since people are likely to trust their friends' suggestions and check-in POIs their friends did before. Conventional art characterizes neighbor impact by matrix-factorization (MF)-based methods which fail to generate explanations simultaneously.

User attributes, where check-in behaviors can also be spontaneous due to users' characteristics such as age, religion, income level, etc. For example, young users may choose to check-in the POIs that other young people love without external stimulus such as friends. GEAPR proposes to understand the underlying correlation between check-in behavior and attributes in a novel manner. Factorization machines-based models are dedicated to learning from attribute data and hence GEAPR utilizes attentional factorization machine (AFM) to learn attribute features.

Geolocation influence, where geolocation influence has a particularly strong impact on POI recommendations because geolocation influence is intuitive such that people are more aware of nearby restaurants, supermarkets, or museums, etc. than distant ones. In GEAPR, the exemplary embodiments fix the POI influence distribution parameterized by Manhattan distance and learn the user preference for each geographical unit. Altogether, GEAPR takes advantage of the attention mechanism to quantify the influences of different factors for each resulting recommendation and performs a thorough analysis of the model interpretability. Interpretability reveals the salience of the factors the model captures from the complex statistics of training data. Also, generating a fully human-readable explanation as a by-product of the ranking score is yet technically infeasible since even users themselves are unable to articulate the exact reasons that motivate a visit to a POI.

It is also noted that the geolocation feature encoding is decoupled from the three other factors that only focus on the user's personal motivation. The main rationale is for the compatibility, although GEAPR is applied to the POI recommendation, GEAPR can be painlessly transplanted to geolocation-irrelevant recommendation scenarios by simply detaching the geolocation module.

In summary, the advantageous of the exemplary embodiments include employing GEAPR, which is a POI recommender that is able to interpret the POI prediction in an end-to-end fashion. GEAPR specifically focuses on four factors, namely, structural context, neighbor impact, user attributes, and geolocation influence, and GEAPR quantifies their influences by numeric values as the feature salience indicators.

User attributes are taken into consideration in GEAPR. Further, an attention mechanism is used to address the recommendation interpretability by means of finding significant factors which are more influential in POI recommendation compared with other features.

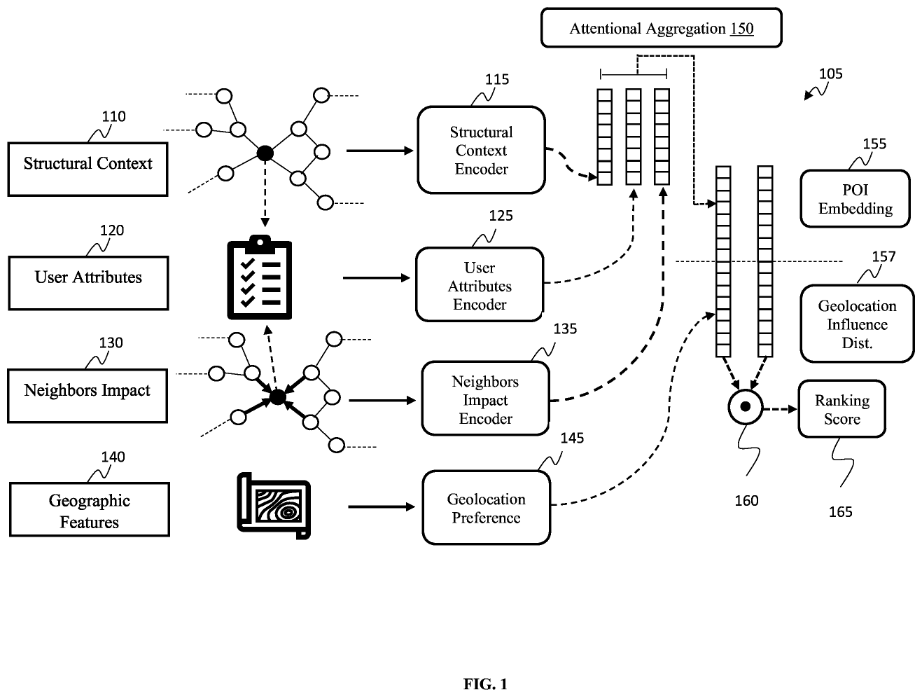

The architecture of GEAPR is shown in FIG. 1. Some notations are summarized in Table 1 below. The inputs of GEAPR 105 include the adjacency matrix of the friendship graph of LBSN Ma, structural context Ms, the users' attributes Y, and the POI influence scores.

TABLE 1
Notations for GEAPR

| Notation(s) | Definition |
|---|---|
| U, P, E | The sets of users, POIs, and friendship relations in |
| | an LBSM. |
| nᵤ, nₚ | The total numbers of users and POIs in an LSBN. |
| G | The friendship graph for users. G = {U,E}. |
| N_{G}(u) | The set of neighbors of user u in G and N_{G}(u) = |
| | {v\|(u, v) ∈ E}. |
| F, m | The set of fields with m fields of user attributes. |
| | m = \|F\|. |
| Mₐ | The adjacency matrix of G, Mₐ ∈ {0, 1}ⁿ^{ᵤ}^{×n}^{ᵤ}^{.} |
| Mₛ | The structural context matrix based on Mₐ, Mₛ ∈ |
| | [symbol] ⁿ^{ᵤ}^{×n}^{ᵤ}. |
| hₛ, hₙ, hₐ | Hidden vectors of structural context, neighbor |
| | impact, and attributes. |
| hᵤ | The attentional aggregation of hₛ, hₙ, and hₐ. |
| h_{g} | The geolocation preference of the user. |
| gₚ | The predefined geographical influence scores of |
| | POI to grids on a map. |
| rₚ | The hidden representation of POI semantics. |
| s_{u,p} | The score representing how likely user u will visit |
| | POI p. |

GEAPR 105 uses three different architectures that are customized for the three factors on the user motivation side. Specifically, a deep feed-forward network is utilized to encode (115) the structural context 110, a graph attention network (GAT) (135) is utilized to model the neighbor impact 130, and an attentional factorization machine (AFM) (125) is utilized for preserving attribute interactions (120). These three sub-modules generate three hidden feature representations individually as hs, hn, and ha. The information from three sources is then merged by an attentional aggregation 150, which is able to reveal the relative salience among them. The merged motivation representation is then combined with geolocation features 140 as constraints, from geolocation preferences 145, and, thus, strongly relevant but distant POIs are removed from the recommendation. GEAPR 105 then takes the dot-product 160 of the graph-enhanced user embedding 157 and the POI embedding 155 to generates a scalar score s_{u,p} (165) representing the likelihood of a user u visiting a POI pin the future.

In order to preserve reliable interpretability while making an accurate recommendation, the building blocks of GEAPR 105 focus on attention-based algorithms. Attention reveals the distribution of salience which can be considered as a form of explanation. In addition, it is worth noting that unlike the tasks where ground truth is usually defined and easily accessible, formal explanations are unavailable from location-based social networking (LBSN) or public datasets for interpretable POI recommendation as ground truth. Therefore, measuring the “correctness” of the generated interpretation is impracticable.

Regarding the structural context factor, the structural context attempts to model the commonality of the close neighbors of a certain user. Intuitively, the proximity of user characters and preferences can be propagated through a few hops of social connections to form cliques within the network. In order to capture social context from network structure, GEAPR 105 utilizes Random Walk with Restart (RWR), a method used for learning community proximity. The structural context features of a user are learned based upon his or her RWR representation. Mathematically, given a network G of nᵤ nodes represented by its adjacency matrix Ma, a starting user u₀ in U, the r-step RWR vector p^{(r)}∈ [symbol] ⁿ^{ᵤ} is computed by:

p^{(r)}=γp⁽⁰⁾+(1−γ)p^{(r-1)}[D⁻¹Mₐ],

where γ denotes the probability that the random walk generator restarts from u₀, p⁽⁰⁾ denotes the corresponding row of u₀ in Ma, and D denotes a diagonal matrix with

Dᵢᵢ=Σⱼ₌₁ⁿ^{ᵤ}M_{a,ij}.

Let R denote the maximum step of the RWR process, the summation of p^{(r)} is considered as the structural context. R is usually set as a small value such as 2 or 3 to make sure only local information is preserved in hs′ and hₛ′=Σᵣ₌₁^{R}p^{(r)}, hₛ′∈ [symbol] ⁿ^{ᵤ}.

However, one issue of encoding the local context is the enormous dimension, that is, the size of hₛ′ is the same scale as the user numbers. Therefore, GEAPR 105 conducts dimension reduction to hₛ′ to generate hs, the latent features of structural context, by a multi-layer perceptron (MLP) with ReLU(x)=max(0, x) as the activation function:

hₛ=MLP(hₛ′), hₛ∈ [symbol] ^{d},

where d is the dimension of the hidden representations.

Regarding the neighborhood impact factor, the second aspect of potential visit stimuli are the direct friends since a user may naturally check in the POIs suggested by friends. The exemplary embodiments thereby focus on the understanding of impact from neighbors N_{G}(u) of a user u.

Graph attention network (GAT) provides an effective way to aggregate information from direct neighbors and compute the attention to pinpoint significant neighbors. Therefore, the exemplary embodiments encode neighborhood impact with the implementation of GAT. Given a user u and the friends of u, N_{G}(u), the hidden neighbor feature hₙ is given as:

$${h}_{n} = σ ( {\sum }_{j ∈ {𝒩}_{G} ( u )} {α}_{uj} {W}_{n} {υ}_{j} ) .$$

σ(⋅) is usually a non-linear function such as ReLU(⋅) or tanh(⋅). Wₙ∈ [symbol] ^{d}^{ₙ}^{×d}^{ₚ} is a learnable weight matrix for the graph attention network that maps all neighbor embeddings to a common space, and vⱼ is derived by the average POI embeddings that user j visited before.

The scalar αᵤⱼ is a weight from user j to u and GEAPR 105 computes aᵤⱼ by the equation below where LeakyReLU advances ReLU in that it allows shrunk negative signal to flow through, “∥” denotes concatenation along an existing dimension, and a∈ [symbol] ^{2d} is a trainable vector that helps compute the attention logits and W∈ [symbol] ^{d×d}^{ₚ}.

$${α}_{uj} = \frac{exp ( LeakyReLU ( {a}^{T} [ W {υ}_{u} ‖ W {υ}_{j} ] ) )}{{\sum }_{i ∈ {𝒩}_{G} ( u )} exp ( LeakyReLU ( {a}^{T} [ W {υ}_{u} ‖ W {υ}_{i} ] ) )}$$

The set of attention weights αᵤⱼ demonstrates the influential neighbors. In addition to concatenation, other ways can also produce attention logits such as dot-product of vⱼ and vᵤ, the matrix-dot-product vⱼ^{T}Wvᵤ, or the non-linear MLP of concatenation of vⱼ and vᵤ. The original GAT can handle multiple attention heads and multiple neighborhood hops. Increased head numbers can preserve information in more sub-spaces and enlarged scopes of direct or nearby users bring in more local context, which both benefit the performance. However, in consideration of the interpretability, the exemplary embodiments simplify the settings to a single head and one-hop neighbors.

Regarding the attribute interactive factor, apart from the effects of social structural context and direct neighbors, the personal attributes are also important factors to motivate the user to visit particular POIs. The combinatorial possibilities of feature interactions create diverse influences on the users' preference towards POIs, which has been thoroughly studied in feature-based recommender systems such as factorization machines (FM). In GEAPR 105, the exemplary embodiments combine feature-based FM methods with the attention mechanism to analyze feature interaction and maintain interpretability.

Embedding the categorical and numerical features into a lower dimensional space is a prerequisite. User attributes can be written as m fields {F₁, . . . , Fₘ} with different values, also known as features. The exemplary embodiments assign a trainable vector to each distinct feature f_{c}∈ [symbol] ^{d}^{ₐ} for categorical field and discretize the continuous value by bucketing and then treating the converted alternative as a categorical feature for the numerical field.

Given the feature embeddings, user attribute impact is modeled as:

$${h}_{a} = {w}_{0} + {\sum }_{i = 1}^{m} {β}_{i} {f}_{i} + {\sum }_{i = 1}^{m} {\sum }_{i = j + 1}^{m} {λ}_{ij} {f}_{i} ⊙ {f}_{j} ,$$

where w₀ is an offset term, βᵢ, and λᵢⱼ are attention weights for first-order and second-order feature interactions. They are computed as follows given feature matrix F={f₁, . . . , fₘ}β=softmax(ReLU(q₁^{T}F)), λᵢⱼ=softmax(q₂^{T}F ReLU(Wa(fᵢ⊙fⱼ)+b)), where q₁, q₂∈ [symbol] ^{d}^{ₐ}, Wa∈ [symbol] ^{d}^{ₐ}^{×d}^{ₐ}, and b∈ [symbol] ^{d}^{ₐ} denote learnable tensors to build attention weights, and ⊙ is the element-wise multiplication. Once more, the exemplary embodiments use the attention weights as the information source for interpretability.

The hₐ equation above includes an enumeration of the first-order features and second-order feature interactions which are incomprehensive compared with the exponential-sized feature interaction space. Studies have shown that the first two orders of features are already capable of contributing sufficient information for learning interactive features and adding higher-order features is only making a marginal information supplement. That being said, GEAPR 105 still enjoys great compatibility with higher-order features interaction models.

Regarding POI geographical influence, in GEAPR 105, the exemplary embodiments model the geographical influence features from two aspects, that is, learnable user geolocational interest and predefined POI area influence. Specifically, the exemplary embodiments first divide, e.g., a city map of POIs into grids with nₗₐₜ units on the latitude axis and n_{long} units on the longitude axis. The exemplary embodiments model the geographical influence of a POI in grid p to a target grid t using the influential scope g_{p,t} as:

$${g}_{p , t} = K ( \frac{{d}_{man} ( p , t )}{{σ}_{g}} )$$

where σ_{g} denotes the standard deviation of distances, K(⋅) denotes a standard normal distribution, and dₘₐₙ(a, b) measures the Manhattan distance from the grid a to grid b. Therefore, the exemplary embodiments can define the influential score vector gₚ of POI p as gₚ∈ [symbol] ⁿ^{_{long}}^{.n}^{ₗₐₜ} which is essentially a flattened 2-dimensional influential score matrix. The exemplary embodiments are also curious about the geographical preference distribution of users which is defined as a learnable parameter representing user preference, h_{g}∈ [symbol] ⁿ^{_{long}}^{.n}^{ₗₐₜ}. The exemplary embodiments define the geographical influence correlation between users and POIs by taking the product h_{g}^{T}gₚ. The overlap between user-preferred regions and POI influential regions can be selected and amplified by multiplication.

Regarding the objective and optimization, after showing the derivations of the representation of the causing factors, the exemplary embodiments show how to make predictions for future check-ins. The exemplary embodiments first aggregate hs, hn, and ha by an attention mechanism shown below since they all encode users motivation.

$${h}_{u} = {π}_{s} \cdot ReLU ( {h}_{s} ) + {π}_{n} \cdot ReLU ( {h}_{n} ) + {π}_{a} \cdot ReLU ( {h}_{a} )$$

$${π}_{x ∈ \{ s , n , a \}} = \frac{exp ( {w}^{T} ReLU ( {h}_{x} ) )}{{\sum }_{{x}^{′} ∈ \{ s , n , a \}} exp ( {w}^{T} ReLU ( {h}_{{x}^{′}} ) )}$$

Then, the following equation computes the possibility of the potential check-in s_{u,p} which is defined by the dot-product with motivation feature and geographical feature of users and POIs. If rₚ represents the motivation-related POI semantics, then:

s_{u,p}=[hᵤ∥h_{g}]·[rₚ∥gₚ]=hᵤ^{T}rₚ+h_{g}^{T}gₚ.

The overall objective function is shown below, which sums a rank loss Lᵣₐₙₖ and a regularization loss L_{reg} weighted by a hyper-parameter.

In GEAPR 105, the exemplary embodiments use L₂ norm as the regularization term.

L=Lᵣₐₙₖ( [symbol] , [symbol] ′)+cL_{reg}

The exemplary embodiments use negative sampling to implement the ranking term that specifically penalize on the negative samples D′ while optimizing the positive samples D. There are two standard ways to implement the ranking loss, Lᵣₐₙₖ, namely pair-wise or point-wise ranking loss.

Point-wise loss forces the positive instances to approach an indicator 1 and pushes the negative instances to indicator 0 via a cross-entropy loss of binary classification.

y=1 if (u, p)∈ [symbol] , y=0 if (u, p)∈ [symbol] ′, and σ(⋅) is the sigmoid function.

$${L}_{rank - po} = - {\sum }_{𝒟 , {𝒟}^{′}} ( y log ( σ ( {s}_{u , p} ) ) + ( 1 - y ) log ( 1 - σ ( {s}_{u , p} ) ) ) .$$

Pair-wise loss tries to capture the partial order relationships in the training data and maintain that order between the scores of positive instances and negative instances.

The exemplary embodiments employ the equation below with (u, p)∈ [symbol] , (u, p′)∈ [symbol] ′, and Δ_{u,p,p′}=s_{u,p}−s_{u,p′}.

$${L}_{rank - pa} = - {\sum }_{𝒟 , {𝒟}^{′}} - {Δ}_{u , p , {p}^{′}} + log ( 1 + exp ( {Δ}_{u , p , {p}^{′}} ) ) .$$

The exemplary embodiments can use gradient descent-based learning algorithms to optimize the parameters since all modules in GEAPR 105 are continuous and differentiable.

Therefore, in summary, point-of-interest (POI) recommendation is an emerging area of research on location-based social networks to analyze user behaviors and contextual check-in information. For this problem, existing approaches, with shallow or deep architectures, have several drawbacks. First, for these approaches, attributes of individuals have been largely ignored. Therefore, it would be difficult to gather sufficient user attribute features to have complete coverage of possible motivation factors. Second, most existing models preserve the information of users or POIs by latent representations without explicitly highlighting salient factors or signals. Consequently, the trained models with unjustifiable parameters provide few persuasive rationales to explain why users favor or dislike certain POIs and what really causes a visit. To overcome these drawbacks, the exemplary embodiments introduce GEAPR 105, a POI recommender that is able to interpret the POI prediction in an end-to-end fashion by adopting an adaptive neural network. GEAPR 105 learns user representations by aggregating different factors, such as structural context, neighbor impact, user attributes, and geolocation influence. GEAPR 105 takes advantage of the triple attention mechanism to quantify the influences of different factors for each resulting recommendation and performs a thorough analysis of the model interpretability.

Thus, GEAPR 105 is a graph-enhanced POI recommendation algorithm that incorporates user friendship network information in addition to user attributes and geolocation features. Specifically, GEAPR 105 decomposes the motivation of user check-ins into four different aspects: social structural context, neighborhood impact, user attribute, and geolocation, and quantifies the importance of each feature. In addition, GEAPR 105 employs the attention mechanism to generate interpretations that reveal the salient motivating factors, influential neighbors, informative attribute interactions, and heated geographical areas, etc.

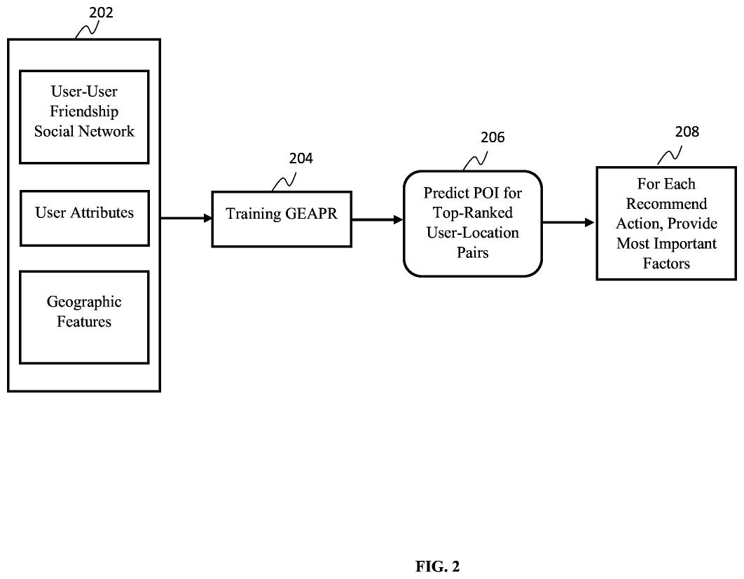

FIG. 2 is a block/flow diagram of an exemplary workflow of the method for implementing the GEAPR, in accordance with embodiments of the present invention.

Block 202 illustrates the user-user friendship social network, the user attributes, and the geographic features.

Block 204 illustrates the training of the GEAPR.

Block 206 illustrates predicting the POI for top-ranked user-location pairs.

Block 208 illustrates that for each recommend action, the most important factors are provided.

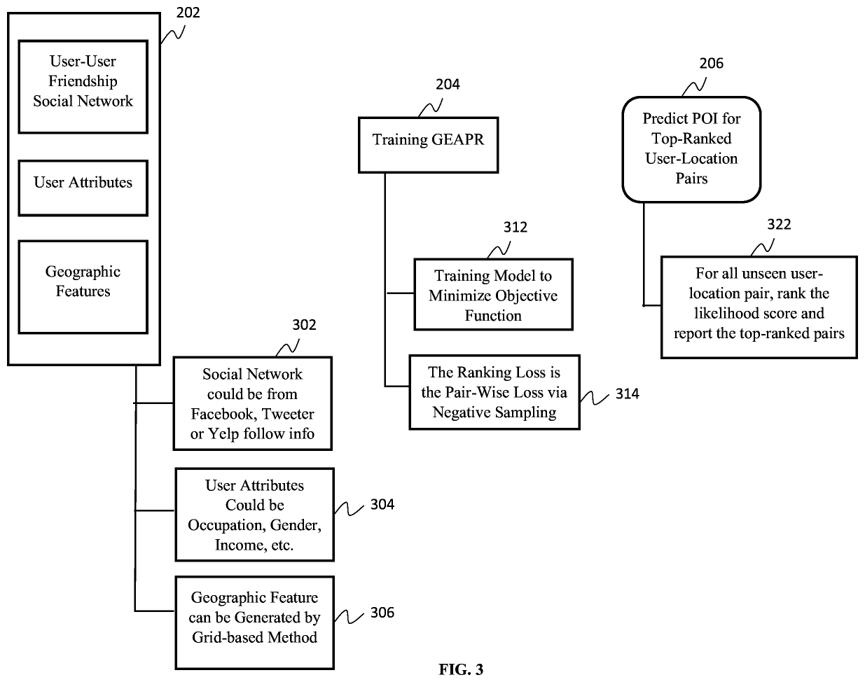

FIG. 3 is a block/flow diagram of exemplary details regarding the workflow of FIG. 2, in accordance with embodiments of the present invention.

Block 202 includes a social network 302 that could be, e.g., from Facebook®, Twitter® or Yelp® information.

Block 202 further includes user attributes 304 that could be, e.g., occupation, gender, income, etc.

Block 202 further includes geographic features 306 that could be generated by, e.g., a grid based method.

Block 204 includes a training model 312 for minimizing the objective function.

Block 204 further includes a ranking loss 314 for the pair-wise loss via negative sampling.

Block 206 includes ranking the likelihood score 322 and reporting the top-ranked pairs for all unseen user-location pairs.

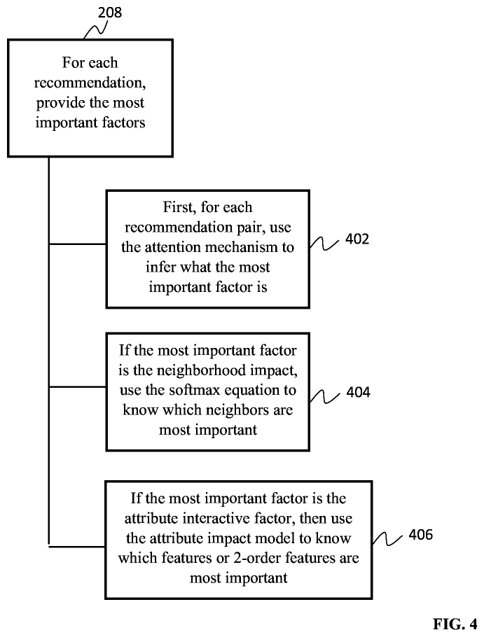

FIG. 4 is a block/flow diagram of further exemplary details regarding the workflow of FIG. 2, in accordance with embodiments of the present invention.

Block 208 includes blocks 402, 404, 406.

In block 402, first, for each recommendation pair, use the attention mechanism to infer what the most important factor is.

In block 404, if the most important factor is the neighborhood impact, use the softmax equation to know which neighbors are most important.

In block 406, if the most important factor is the attribute interactive factor, then use the attribute impact model to know which features or 2-order features are most important.

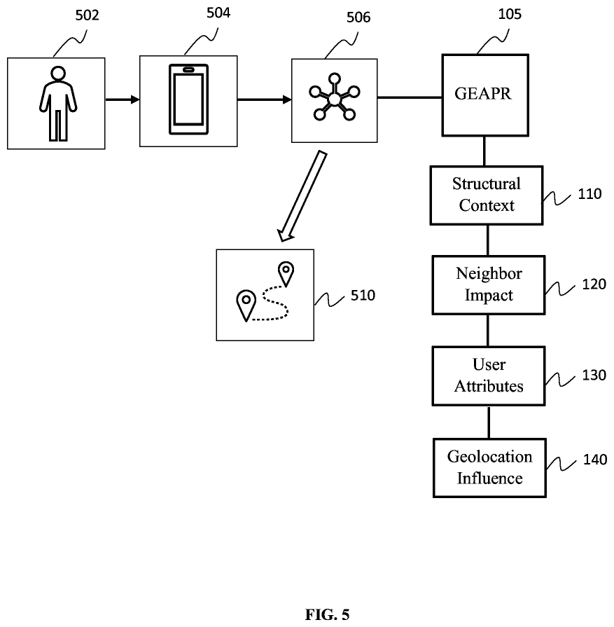

FIG. 5 is a block/flow diagram of an example practical application of the GEAPR, in accordance with embodiments of the present invention.

In one practical application, a user 502 employs a capturing device 504, such as a camera, to capture access a location-based social network 506. The location-based social network 506 can employ the GEAPR 105 to determine the structural context 110, the neighbor impact 120, the user attributes 130, and the geolocation influence 140 of a search conducted by the user 502. The search may be for reviews of a specific restaurant located in close proximity to the user 502. The GEAPR 105 can aid the location-based social network 506 to output a result or prediction 510.

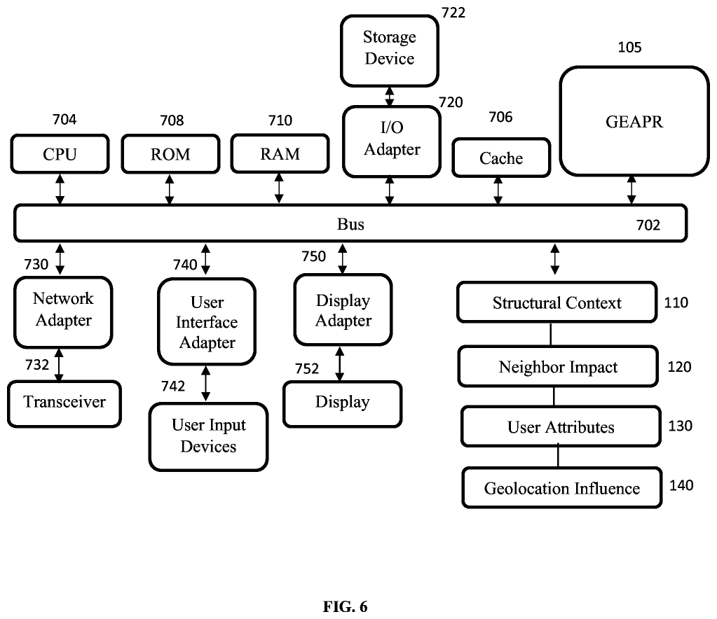

FIG. 6 is block/flow diagram of an exemplary processing system for the GEAPR, in accordance with embodiments of the present invention.

The processing system includes at least one processor or processor device (CPU) 704 operatively coupled to other components via a system bus 702. A cache 706, a Read Only Memory (ROM) 708, a Random Access Memory (RAM) 710, an input/output (I/O) adapter 720, a network adapter 730, a user interface adapter 740, and a display adapter 750, are operatively coupled to the system bus 702. The GEAPR 105 can be connected to bus 702. The GEAPR 105 can compute or determine the structural context 110, the neighbor impact 120, the user attributes 130, and the geolocation influence 140.

A storage device 722 is operatively coupled to system bus 702 by the I/O adapter 720. The storage device 722 can be any of a disk storage device (e.g., a magnetic or optical disk storage device), a solid state magnetic device, and so forth.

A transceiver 732 is operatively coupled to system bus 702 by network adapter 730.

User input devices 742 are operatively coupled to system bus 702 by user interface adapter 740. The user input devices 742 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 742 can be the same type of user input device or different types of user input devices. The user input devices 742 are used to input and output information to and from the processing system.

A display device 752 is operatively coupled to system bus 702 by display adapter 750.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, processor devices, controllers, memories, and so forth, in various configurations can also be utilized as readily appreciated by one of ordinary skill in the art. These and other variations of the processing system are readily contemplated by one of ordinary skill in the art given the teachings of the present invention provided herein.

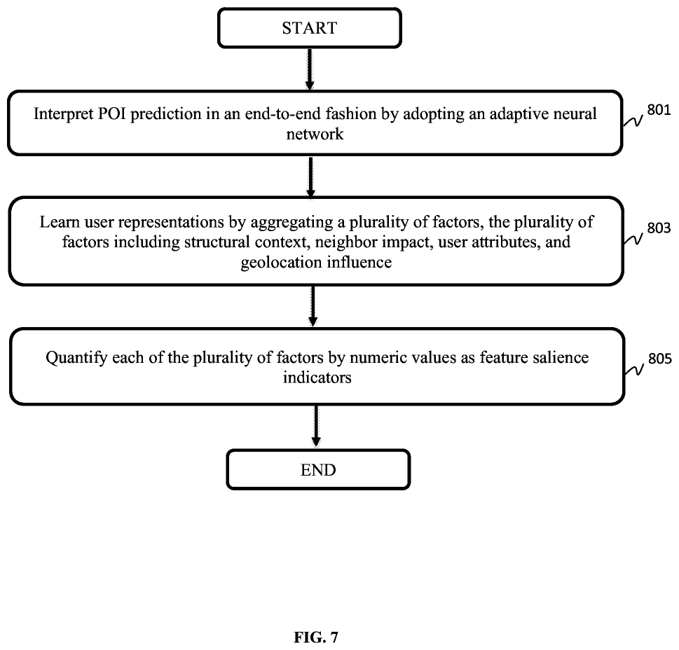

FIG. 7 is a block/flow diagram of an exemplary method for implementing the GEAPR, in accordance with embodiments of the present invention.

At block 801, interpret POI prediction in an end-to-end fashion by adopting an adaptive neural network.

At block 803, learn user representations by aggregating a plurality of factors, the plurality of factors including structural context, neighbor impact, user attributes, and geolocation influence.

At block 805, quantify each of the plurality of factors by numeric values as feature salience indicators.

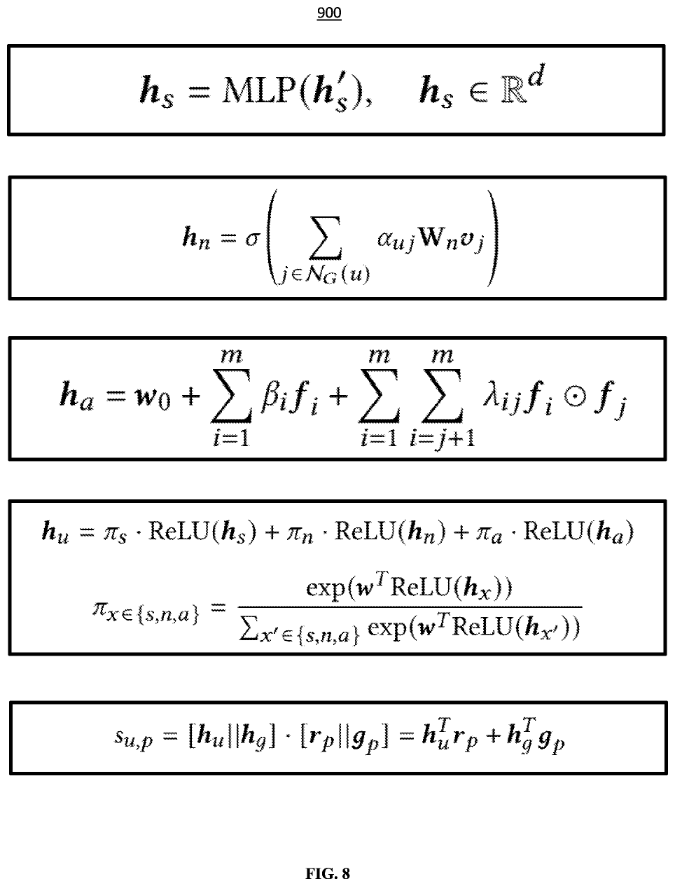

FIG. 8 is a block/flow diagram of exemplary equations employed for the hidden feature representations, in accordance with embodiments of the present invention.

Equations 900 illustrate the three hidden feature representations hₛ, hₙ, and hₐ, as well as the aggregate hᵤ and the ranking score s_{u,p}.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method executed on a processor for employing a graph enhanced attention network for explainable point-of-interest (POI) recommendation (GEAPR), the method comprising:
interpreting POI prediction in an end-to-end fashion by adopting an adaptive neural network;
learning user representations by aggregating a plurality of factors, the plurality of factors including structural context, neighbor impact, user attributes, and geolocation influence; and
quantifying each of the plurality of factors by numeric values as feature salience indicators.

2. The method of claim 1, wherein a deep feed-forward network is utilized to encode the structural context, a graph attention network (GAT) is utilized to model the neighbor impact, and an attention factorization machine (AFM) is utilized to preserve attribute interactions such as to generate three hidden feature representations individually.

3. The method of claim 2, wherein the three hidden feature representations are merged by attention aggregation to generate a merged motivation representation.

4. The method of claim 3, wherein the merged motivation representation is combined with geolocation features as constraints to remove distant POIs from a recommendation.

5. The method of claim 4, wherein the GEAPR takes a dot-product of graph-enhanced user embedding and POI embedding to generate a scalar score representing a likelihood of a user visiting a POI in the future.

6. The method of claim 2, wherein the first hidden feature representation is given by:
hₛ=MLP(hₛ′), hₛ∈ [symbol] ^{d},
where MLP is a multi-layer perceptron, d is a dimension of a hidden representation, and hₛ′=Σᵣ₌₁^{R}p^{(r)}, hₛ′∈ [symbol] ⁿ^{ᵤ}, where R is a maximum step of a Walk with Restart (RWR) process, and p^{(r)} is a summation of the structural context.

7. The method of claim 2, wherein the second hidden feature representation is given by:
$${h}_{n} = σ ( {\sum }_{j ∈ {𝒩}_{G} ( u )} {α}_{uj} {W}_{n} {υ}_{j} ) ,$$
where σ(⋅) is a non-linear function, Wₙ is a learnable weight matrix for the GAT that maps all neighbor embeddings to a common space, vⱼ is derived by an average of POI embeddings that user j visited before, αᵤⱼ is a weight from user j to u, and N_{G}(u) is an impact from neighbors of the user u.

8. The method of claim 2, wherein the third hidden feature representation is given by:
$${h}_{a} = {w}_{0} + {\sum }_{i = 1}^{m} {β}_{i} {f}_{i} + {\sum }_{i = 1}^{m} {\sum }_{i = j + 1}^{m} {λ}_{ij} {f}_{i} ⊙ {f}_{j} ,$$
where w₀ is an offset term, βᵢ and λᵢⱼ are attention weights for first-order and second-order feature interactions, fi, fj are distinct features, and ⊙ is an element-wise multiplication.

9. A non-transitory computer-readable storage medium comprising a computer-readable program for employing a graph enhanced attention network for explainable point-of-interest (POI) recommendation (GEAPR), wherein the computer-readable program when executed on a computer causes the computer to perform the steps of:
interpreting POI prediction in an end-to-end fashion by adopting an adaptive neural network;
learning user representations by aggregating a plurality of factors, the plurality of factors including structural context, neighbor impact, user attributes, and geolocation influence; and
quantifying each of the plurality of factors by numeric values as feature salience indicators.

10. The non-transitory computer-readable storage medium of claim 9, wherein a deep feed-forward network is utilized to encode the structural context, a graph attention network (GAT) is utilized to model the neighbor impact, and an attention factorization machine (AFM) is utilized to preserve attribute interactions such as to generate three hidden feature representations individually.

11. The non-transitory computer-readable storage medium of claim 10, wherein the three hidden feature representations are merged by attention aggregation to generate a merged motivation representation.

12. The non-transitory computer-readable storage medium of claim 11, wherein the merged motivation representation is combined with geolocation features as constraints to remove distant POIs from a recommendation.

13. The non-transitory computer-readable storage medium of claim 12, wherein the GEAPR takes a dot-product of graph-enhanced user embedding and POI embedding to generate a scalar score representing a likelihood of a user visiting a POI in the future.

14. The non-transitory computer-readable storage medium of claim 10, wherein the first hidden feature representation is given by:
hₛ=MLP(hₛ′), hₛ∈ [symbol] ^{d},
where MLP is a multi-layer perceptron, d is a dimension of a hidden representation, and hₛ′=Σᵣ₌₁^{R}p^{(r)}, hₛ′∈ [symbol] ⁿ^{ᵤ}, where R is a maximum step of a Walk with Restart (RWR) process, and p^{(r)} is a summation of the structural context.

15. The non-transitory computer-readable storage medium of claim 10, wherein the second hidden feature representation is given by:
$${h}_{n} = σ ( {\sum }_{j ∈ {𝒩}_{G} ( u )} {α}_{uj} {W}_{n} {υ}_{j} ) ,$$
where σ(⋅) is a non-linear function, Wₙ is a learnable weight matrix for the GAT that maps all neighbor embeddings to a common space, vⱼ is derived by an average of POI embeddings that user j visited before, αᵤⱼ is a weight from user j to u, and N_{G}(u) is an impact from neighbors of the user u.

16. The non-transitory computer-readable storage medium of claim 10, wherein the third hidden feature representation is given by:
$${h}_{a} = {w}_{0} + {\sum }_{i = 1}^{m} {β}_{i} {f}_{i} + {\sum }_{i = 1}^{m} {\sum }_{i = j + 1}^{m} {λ}_{ij} {f}_{i} ⊙ {f}_{j} ,$$
where w₀ is an offset term, βᵢ and λᵢⱼ are attention weights for first-order and second-order feature interactions, fi, fj are distinct features, and ⊙ is an element-wise multiplication.

17. A system for employing a graph enhanced attention network for explainable point-of-interest (POI) recommendation (GEAPR), the system comprising:
a memory; and
one or more processors in communication with the memory configured to:
interpret POI prediction in an end-to-end fashion by adopting an adaptive neural network;
learn user representations by aggregating a plurality of factors, the plurality of factors including structural context, neighbor impact, user attributes, and geolocation influence; and
quantify each of the plurality of factors by numeric values as feature salience indicators.

18. The system of claim 17, wherein a deep feed-forward network is utilized to encode the structural context, a graph attention network (GAT) is utilized to model the neighbor impact, and an attention factorization machine (AFM) is utilized to preserve attribute interactions such as to generate three hidden feature representations individually.

19. The system of claim 18, wherein the three hidden feature representations are merged by attention aggregation to generate a merged motivation representation.

20. The system of claim 19,
wherein the merged motivation representation is combined with geolocation features as constraints to remove distant POIs from a recommendation; and
wherein the GEAPR takes a dot-product of graph-enhanced user embedding and POI embedding to generate a scalar score representing a likelihood of a user visiting a POI in the future.
